(19) United States
(12) Patent Application Publication
(10) Pub. No.: US 2008/0059911 A1
(43) Pub. Date: Mar. 6, 2008

(54) ADVANCED PLAYER

(76) Inventors: Taneli Kulo, Turku (FI); Janne M. Martama, Salo (FI); Jaakko Arvilommi, Turku (FI)

Correspondence Address: PERMAN & GREEN, 425 POST ROAD, FAIRFIELD, CT, 06824, US

(21) Appl. No.: 11/469,591

(22) Filed: Sep. 1, 2006

(51) Int. Cl. G06F 3/00

(52) U.S. Cl. 715/853

(57) ABSTRACT

A method for selecting an item in a multi-dimensional hierarchy is disclosed. The method includes displaying a first list of items belonging to a dimension of said multi-dimensional hierarchy in a display view; displaying second list of items representing other dimensions of the multi-dimensional hierarchy in the display view; enabling selection of a displayed item; upon selection of an item from the first list, displaying a third list of items belonging to a lower hierarchical level for enabling further selection of displayed items, wherein the third list is hierarchically associated with the selected item; and upon selection of an item from the second list, displaying a fourth list of items belonging to a dimension of the multi-dimensional hierarchy associated with the selected item. Applications, apparatuses and computer programs for implementing the method are also disclosed.

### TECHNICAL FIELD

The disclosed embodiments relate to methods for selecting items in a portable apparatus, a selection application, a portable apparatus comprising a display and means for navigating, and a computer-readable medium having computer-executable components.

### BACKGROUND

Many times, items are stored in a device with processing and storage capabilities, such as a computer, a media player, and nowadays also mobile communication The items in the tree structure are assigned a hierarchical level, and each item, except items on the top or ‘root’ level, is associated with another item on a higher level. As the number of items increases, and/or the complexity of the tree structure increases, it becomes more cumbersome for a user to manage browsing the items and to keep track of its position in the hierarchical tree structure. This is especially problematic in an apparatus with a small physical size, since the display of the device accordingly provides less displaying area. U.S. Pat. No. 6,928,433 B2, which is hereby incorporated by reference, discloses a solution for organizing and selecting tracks for a playlist in a portable music player. However, it is believed that improvements can be made that facilitates for a user to select among a plurality of items.

### SUMMARY

In view of the above, it would be advantageous to solve or at least reduce the problems discussed above. In particular, the disclosed embodiments provide a user friendly and efficient selection and browsing of items in a portable apparatus.

According to a first aspect, there is provided a method for selecting an item in a multi-dimensional hierarchy, comprising displaying a first list of items belonging to a dimension of said multi-dimensional hierarchy in a display view; displaying second list of items representing other dimensions of said multi-dimensional hierarchy in said display view; enabling selection of a displayed item; upon selection of an item from said first list, displaying a third list of items belonging to a lower hierarchical level for enabling further selection of displayed items, wherein said third list is hierarchically associated with the selected item; and upon selection of an item from said second list, displaying a fourth list of items belonging to a dimension of said multi-dimensional hierarchy associated with the selected item.

The method may comprise selecting from any displayed list and displaying items accordingly until a desired item for rendering is selected.

The method may further comprise rendering a media item associated with said selected item upon selection of a media item.

The method may further comprise indenting said inserted third list compared to said first list.

The method may further comprise, upon selection of an item from said second list, concealing said first list of items; and inserting into said second list of items an item representing the dimension of said concealed first list.

According to a second aspect, there is provided an item selection application for a portable apparatus comprising a display and navigation means, causing a first list of items belonging to a dimension of said multi-dimensional hierarchy to be displayed; and a second list of items representing other dimensions of said multi-dimensional hierarchy to be displayed, the application being capable of receiving a selection of a displayed item, wherein upon selection of an item from said first list, causing a third list of items belonging to a lower hierarchical level to be displayed for enabling further selection of displayed items, wherein said third list is hierarchically associated with the selected item; and upon selection of an item from said dimension of said multi-dimensional hierarchy associated with the selected item to be displayed.

According to a third, there is provided a portable apparatus comprising a display and an item navigation device arranged to enable navigation among items displayed on said display, the apparatus being arranged to display a first list of items belonging to a dimension of a multi-dimensional hierarchy and a second list of items representing other dimensions of said multi-dimensional hierarchy, the item navigation device being enabled to receive a selection of a displayed item, wherein upon selection of an item from said first list, the apparatus is arranged to display a third list of items belonging to a lower hierarchical level for enabling further selection of displayed items, wherein said third list is hierarchically associated with the selected item; and upon selection of an item from said second list, the apparatus is arranged to display a fourth list of items belonging to a dimension of said multi-dimensional hierarchy associated with the selected item.

According to a fourth aspect, there is provided a computer-readable medium having computer-executable components comprising instructions for displaying a first list of items belonging to a dimension of said multi-dimensional hierarchy in a display view; displaying second list of items representing other dimensions of said multi-dimensional hierarchy in said display view; enabling selection of a displayed item; upon selection of an item from said first list, displaying a third list of items belonging to a lower hierarchical level for enabling further selection of displayed items, wherein said third list is hierarchically associated with the selected item; and upon selection of an item from said second list, displaying a fourth list of items belonging to a dimension of said multidimensional hierarchy associated with the selected item.

The second, third, and fourth aspects may be embodied with similar features as those demonstrated for the first aspect.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

Other features and advantages of the disclosed embodiments will appear from the following detailed disclosure, from the attached dependent claims as well as from the drawings.

### BRIEF DESCRIPTION OF THE DRAWINGS

The above, as well as additional objects, features and advantages of the disclosed embodiments, will be better understood through the following illustrative and non-limiting detailed description of preferred embodiments with reference to the appended drawings, where the same reference numerals will be used for similar elements, wherein:

FIG. 1 shows an exemplary apparatus;

FIG. 2 shows a display view;

FIG. 3 shows a display view;

FIG. 4 shows a display view;

FIG. 5 schematically shows item selection procedure;

FIG. 6 is an illustration of an item selection procedure; and

FIG. 7 is a flow chart illustrating a method according to an embodiment.

### DETAILED DESCRIPTION OF EMBODIMENTS

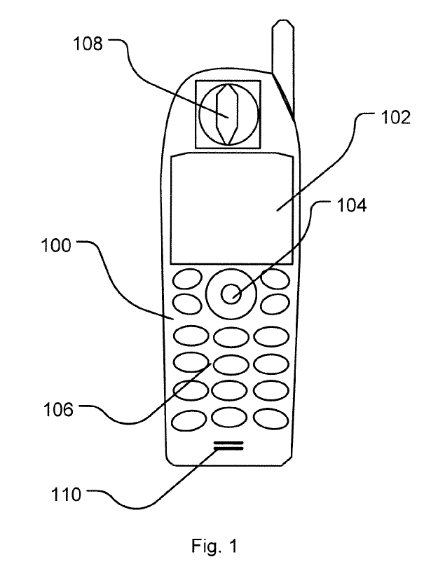

FIG. 1 shows an exemplary environment, in which the present invention can be used, in form of a mobile communication apparatus 100 comprising a display 102 and means 104 for navigating among items (not shown) displayed in a display area 102. The navigation means 104 can be a rotating input, a joystick, a touch pad, but can also be implemented using a touch sensitive display, wherein the displayed items directly can be tapped by a user for selection, or be voice activated via a headset or a built-in microphone. The mobile communication apparatus can also comprise other elements normally present in such an apparatus, such as a keypad 106, a speaker 108, a microphone 110, a processor (not shown), a memory (not shown), etc.

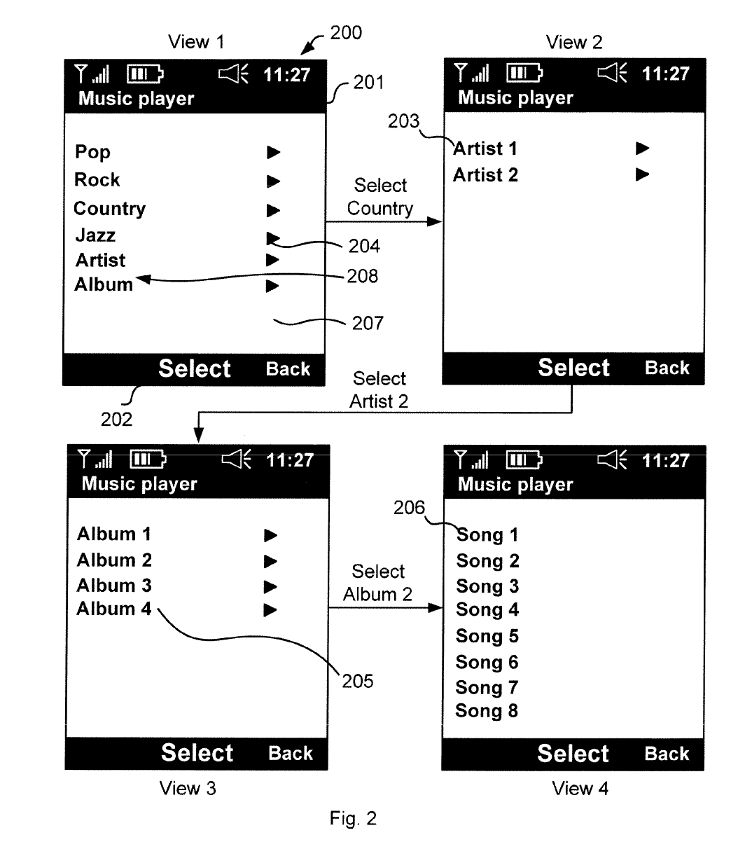

FIG. 2 illustrates an example of a common display view 200, e.g. in a mobile communication apparatus, a PDA, a portable media player, a digital camera, etc., comprising a general status indication section 201, a softkey bar 202 and a general display area 207. The general status indication section 201 can for example include symbols for battery status, reception quality, speaker on/off, present mode, clock time, etc. The status indication section is not in any way limited to only include these symbols. Thus, other symbols in any shape, form or colour can occur. The softkey bar 202, situated at the bottom of the display view, is operable using the navigation means 104 mentioned in conjunction with FIG. 1. The function of these softkeys are not limited by the functions indicated in the figure.

The preferred function of the general display area 207, residing between the status indication section 200 at the top and the softkey bar 202 at the bottom, is to display information from running applications in the apparatus. In our case the display area 207 displays lists of items which are manoeuvrable with the aid of navigation means, such as the navigation means 104 in FIG. 1.

Throughout this disclosure, references have been made to a hierarchical structure. The hierarchical structure can be dynamically assigned, as will be discussed below. However, a default structure can be fixed by a specification or application.

The navigation and the dynamics of the hierarchy structure will be explained by a series of examples, all in a context of a music library for the sake of simplicity in understanding. However, as will be readily understood by a skilled person, the principle applies in a similar way to other contexts, such as phone books, photo albums, web link collections, To Do lists, etc.

A music track can have a set of meta data associated. The meta data can comprise name of artist, song title, album title, composer, producer, genre, etc. Each of these types of data will be referenced to as a ‘dimension’ in this disclosure.

In our example in FIG. 2, the display area further comprises a hierarchical item lists of meta data categories 203 with associated arrows 204 indicating further selectable sub levels of the hierarchically associated items. The user of the mobile communication apparatus can be prompted to select one of the meta data categories define as the highest level in the hierarchy. For example, the meta data category, i.e. the dimension ‘Genre’ has been selected to be the top level. In view 1 a list of sub level items of the dimension can then be displayed, such as ‘Pop’, ‘Rock’, ‘Country’, and ‘Jazz’, which then are considered as ‘values’ in the dimension ‘Genre’. If a user then selects one of the items from the list, for example ‘Country’, a new display view appears, view 2 in FIG. 2, displaying a new sub level with, in this case, an item list of country artists 203. A further selection by the user, for example ‘Artist 2’, will in its turn display a new display view, view 3, where a new hierarchical item list of albums, from that particular artist, which are hierarchical associated with the selected artist item is displayed. If the user for example selects the item ‘Album 2’ a new display view, view 4, showing a list of items of songs hierarchically related to the selected album list item appears. The songs, which in this particular example is on the lowest level in the hierarchy, can be rendered. Returning to view 1, the user is able to re-select which dimension to define the root level, i.e. top of hierarchy, by selecting any of the other available dimensions 208, which are displayed, and here represented by the dimensions ‘Artist’ and ‘Album’.

Note that in most apparatuses in question, such as in the example above, the hierarchy association between meta data categories are predefined and not user configurable.

When the amount of items in the meta data categories, such as artists, albums and songs, increases rapidly, as they tend to do nowadays in such apparatuses with large storage space, the navigation among the hierarchical ordered items becomes cumbersome to navigate and it is easy to lose ones bearings of where in the hierarchical structure one are.

One way of reducing the navigation difficulties and mitigating the feeling of being lost when navigating large amounts of hierarchical structured items, in a mobile communication apparatus, or other apparatus with a limited display area such as a PDA, portable media player, etc., is presented in the following examples of embodiments.

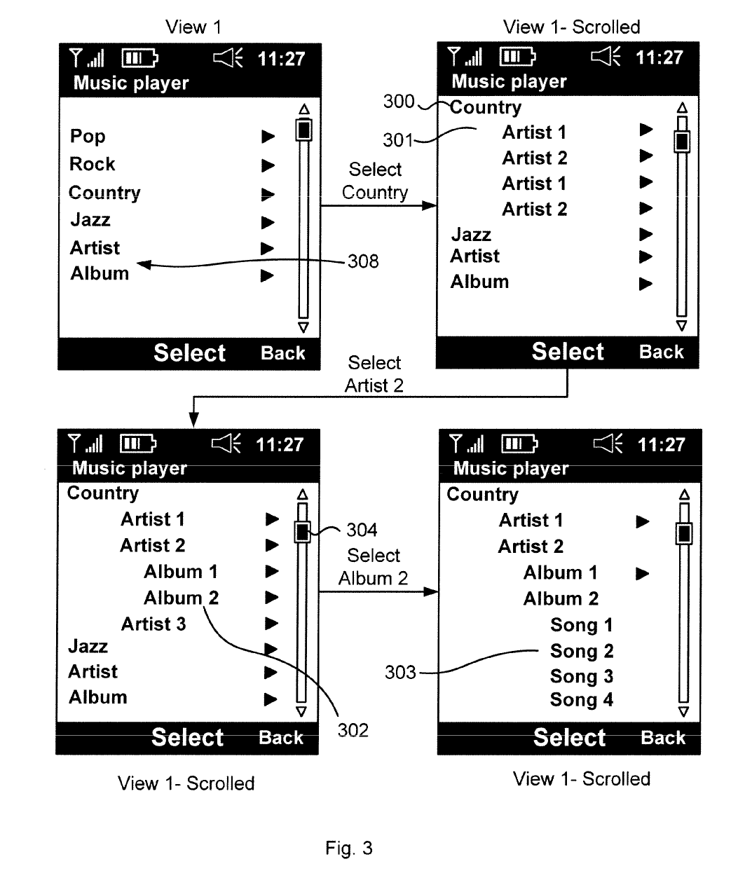

FIG. 3 shows an embodiment where the common display area is the same as in the example in FIG. 2, and the same hierarchically associated item lists with meta data are used as in the example in FIG. 2. A user can be prompted to select one of several meta data values from a dimension, such as ‘Pop’, ‘Country’, ‘Rock’ and ‘Jazz’, to define the top or root level in the hierarchy, which in this example is the dimension ‘Genre’. The user is able to re-select which dimension to define as the root level, i.e. top of hierarchy, by selecting any of the other available dimensions 308, which are displayed, and here represented by the dimensions ‘Artist’ and ‘Album’. If a user selects the meta data item ‘Country’ 300, in view 1, from the top hierarchical items list, the whole items list with will be scrolled, within view 1, so that item ‘Country’ is positioned at the top 301 of the display area and an preferably indented items list of artists 301 is inserted between the items ‘Country’ and ‘Jazz’. The scrolling of items can be indicated by a scroll bar 304 placed at the right hand side of the display area 304. If a user chooses to select item ‘Artist 2’ from said indented list of items, a new indented list of album items are inserted between said ‘Artist 2’ and ‘Artist 3’ 302. If item ‘Album 2’ is selected a new indented items list comprising song items 303 hierarchically related to the ‘Album 2’ items are inserted in the same manner, in said view 1. The displaying of the hierarchical associated items ‘Country’, ‘Artist 2’, ‘Album 2’ and ‘Song’, are all displayed as an indented tree structure in the same view of the display area, not in separate views as in the example in FIG. 2. The complete hierarchical tree structure can be scrollable in the same view as indicated by the optional scroll bar 304.

The tree structure makes navigating among the items very user friendly and it clearly shows how items are related to each other and where in the structure one are, which mitigates the effect of feeling lost in the tree structure. Note that this example comprises a plurality of levels, but the user can choose to have fewer, as well as more, levels for the dynamically selected hierarchy, depending on the desires of the user. In the example discussed above, a user has been able to set up the dynamically assigned hierarchy tree structure, but it is readily understood that this set-up can be made by an administrator of the media library, or which type of items to be structured, a service provider, or an operator.

The optional scrollbar 304 can be utilized to scroll through the hierarchical structure even when all available items do not fit into the screen, and easily select items on different hierarchical levels without backing through a series of display views corresponding to the different levels in the hierarchy.

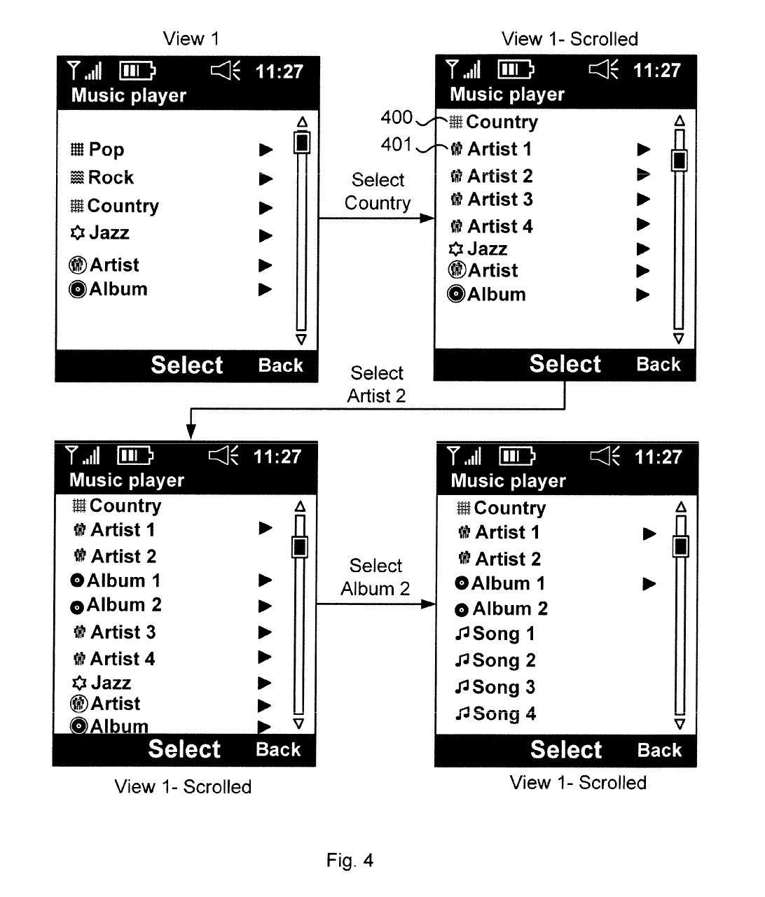

If the display area of the apparatus is extremely precious, such as in a small sized cell phone, an alternative way of communicating the hierarchical level information is by using visual cues and thereby compacting the display space needed for the hierarchical structure. An example of this is shown in FIG. 4 where the visual cues are represented by symbols. Each item list belonging to a specific hierarchical level share the same icon. For example the ‘Country’ item is indicated by a square checkered object 400 in front of the item name, the item ‘Artist 1’ has a ‘crowd of people’ object 401 and so on. The symbol will in this case serve as a visual cue, and group similar items and indicate which level in the hierarchical tree structure the item or the group of items belongs to.

A way of enhancing the compacted hierarchical structure presented in FIG. 4 is to place a visual cue (not shown) on the top of the display area which tells the user on which level in the hierarchical structure one are, e.g. to place symbols, corresponding to the symbol representing a specific hierarchical level in the structure, separated by slashes.

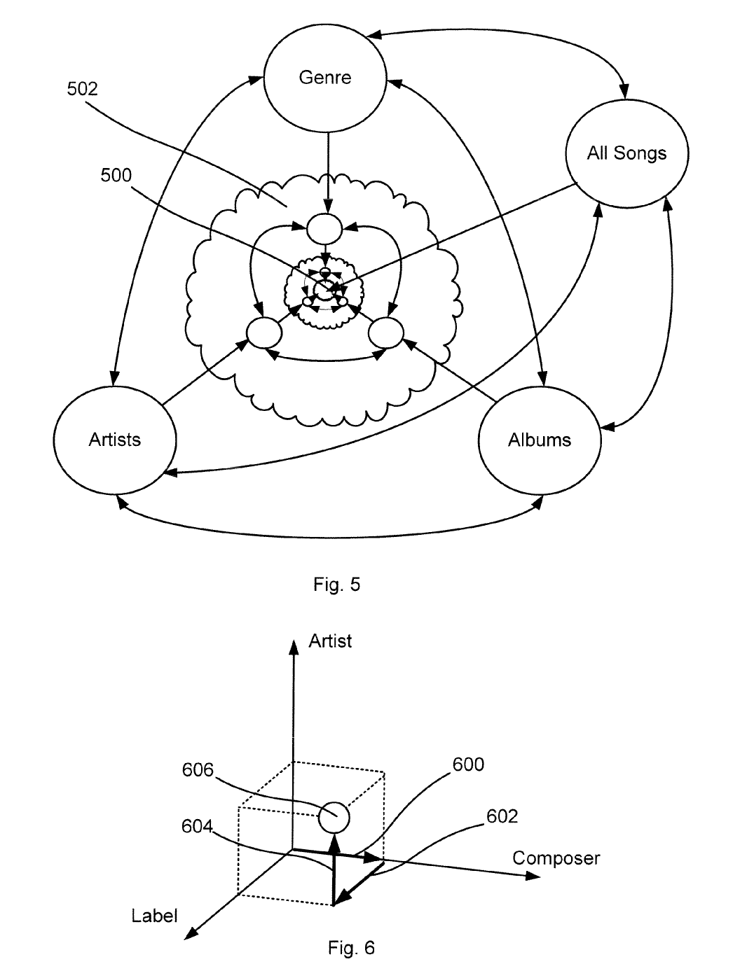

The navigation of the display view can be illustrated as shown in FIG. 5. Inserting an new items list upon selection of a value for a dimension is equivalent to moving inwards among the different states shown in FIG. 5. Upon selection of another dimension is equivalent to moving around between the states. In the centre 500 of FIG. 5, the ‘leaf’ level of the structure, i.e. the lowest level in the hierarchy, is present and comprising the renderable items that can be selected for rendering, which in this example is the songs. When the item ‘Country’ is selected from the ‘Genre’ items list, corresponding to the ‘Genre’ state in FIG. 5, a new items list with e.g. ‘Albums’ or ‘Artists’ is inserted in the same display view between the items of the higher level which corresponds to moving to the ‘Albums’ or ‘Artists’ state in the outer cloud 502. The user is thus able to select and move on to next hierarchical level until one or more preferred songs are present for rendering. Optionally, a selection of items in the states can in this example lead to an items list containing all ‘Song’ items. Thus, all songs or a subset of all ‘Song’ items, depending on from which state the ‘Song’ item is selected from can be reached by navigation for rendering the selected song or songs.

FIG. 6 is an illustration of an example of a selection where at least a three-dimensional meta data is present. In this example, a first selection 600 is made in the ‘Composer’ dimension, where e.g. the value ‘Mozart’ is selected. The user then navigates further and selects ‘Label’ to be the next lower level in the hierarchy. The value ‘Deutsche Grammophon’ is selected 602, and then the user navigates and selects ‘Artist’ as next lower level in the hierarchy. Here, the user selects 604 ‘Karajan’ as value, and will be presented a number of works 606 by Mozart, issued on the label ‘Deutsche Grammophon’ and conducted by Herbert von Karajan, and can for example select Rex Tremendae Requiem to be played. More or less dimensions are possible, and the selection can be referred to as a multi-dimensional cube selection.

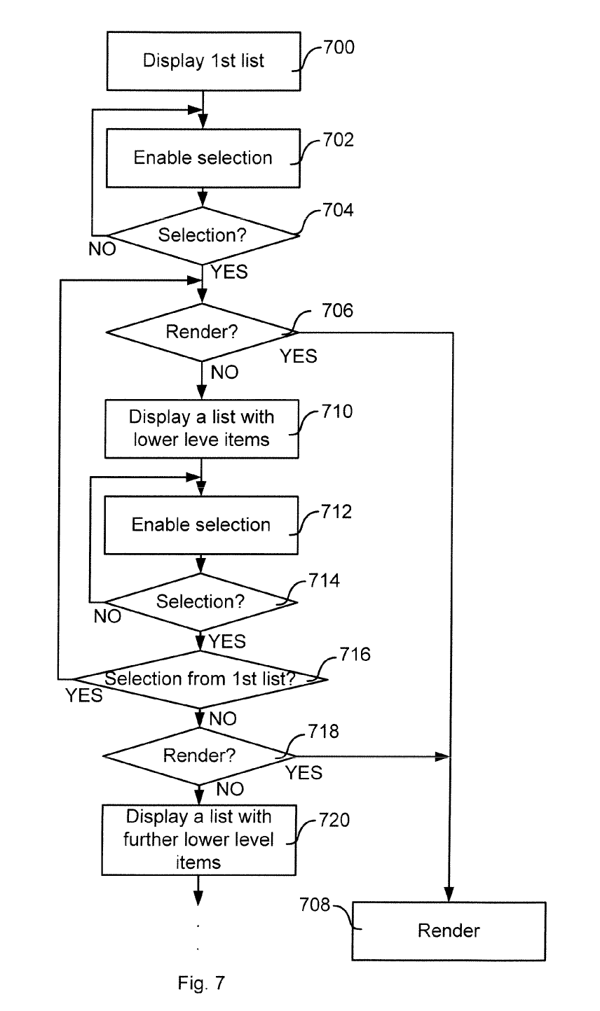

FIG. 7 is a flow chart illustrating a method according to an embodiment, where a user refines the search through the multi-dimensional cube. It is readily understood that the complexity of the method will increase as the number of levels in a corresponding hierarchical structure increases. Thus, the method illustrated by FIG. 7 should be regarded as exemplary, and similar methods related to more or less complex hierarchical structures are readily understood when reading the description below with reference to FIG. 7.

In a displaying step 700, a first list of items belonging to a higher hierarchical level is displayed. Thus, in a selection enablement step 702, a user is enabled to make a selection of a first item among the higher hierarchical level items, wherein it is checked 704 whether any selection is made. Thus, selection enablement step 702 is processed until there has been a selection. Upon selection from a second list, i.e. selecting another root dimension, anywhere in the flow will cause the process to return to step 700 and display a new list accordingly. It can also be checked 706 if selection indicates that information associated with the selected item should be rendered directly. If that is the case, a rendering step 708 will be processed. Otherwise, another list of lower level items is displayed in displaying step 710, wherein this list comprises items hierarchically associated with the selected first item. Thus, in a second selection enablement step 712, a user is enabled to make a selection of a second item among the displayed items, wherein it is checked 714 whether any selection is made. Thus, the selection enablement step 712 is processed until there has been a selection.

Optionally, there can be checked 716 if the selection is made of an item from the first list, wherein a list of items hierarchically associated with the selected item is displayed, or, if the selected item is the first item, concealing the second list and thus returning to displaying step 700. As previously noted, upon selection from a second list, i.e. selecting another root dimension, anywhere in the flow will cause the process to return to step 700 and display a new list accordingly.

It can also be checked 718 if selection indicates that information associated with the selected item should be rendered directly. If that is the case, a rendering step 708 will be processed. Otherwise, another list of further lower level items is displayed in displaying step 720. As indicated by dots, this procedure can continue for as many steps as there is available levels in the hierarchy.

1. A method for selecting an item in a multi-dimensional hierarchy, comprising
displaying a first list of items belonging to a dimension of said multi-dimensional hierarchy in a display view;
displaying second list of items representing other dimensions of said multi-dimensional hierarchy in said display view;
enabling selection of a displayed item;
upon selection of an item from said first list, displaying a third list of items belonging to a lower hierarchical level for enabling further selection of displayed items, wherein said third list is hierarchically associated with the selected item; and
upon selection of an item from said second list, displaying a fourth list of items belonging to a dimension of said multi-dimensional hierarchy associated with the selected item.

2. The method according to claim 1, comprising selecting from any displayed list and displaying items accordingly until a desired item for rendering is selected.

3. The method according to claim 1, further comprising rendering a media item associated with said selected item upon selection of a media item.

4. The method according to claim 1, further comprising indenting said inserted third list compared to said first list.

5. The method according to claim 1, further comprising, upon selection of an item from said second list, concealing said first list of items; and inserting into said second list of items an item representing the dimension of said concealed first list.

6. An item selection application for a portable apparatus comprising a display and navigation means, causing
a first list of items belonging to a dimension of said multi-dimensional hierarchy to be displayed; and
a second list of items representing other dimensions of said multi-dimensional hierarchy to be displayed,
the application being capable of receiving a selection of a displayed item, wherein upon selection of an item from said first list, causing a third list of items belonging to a lower hierarchical level to be displayed for enabling further selection of displayed items, wherein said third list is hierarchically associated with the selected item; and upon selection of an item from said second list, a fourth list of items belonging to a dimension of said multi-dimensional hierarchy associated with the selected item to be displayed.

7. The application according to claim 6, being capable of receiving selections from any displayed list and causing items to be displayed accordingly until a desired item for rendering is selected.

8. The application according to claim 6, further comprising rendering a media item associated with said selected item upon selection of a media item.

9. The application according to claim 6, further causing indentation of said inserted third list compared to said first list.

10. The application according to claim 6, further causing, upon selection of an item from said second list, said first list of items to be concealed; and an item representing the dimension of said concealed first list to be inserted into said second list of items.

11. A portable apparatus comprising a display and an item navigation device arranged to enable navigation among items displayed on said display, the apparatus being arranged to display a first list of items belonging to a dimension of a multi-dimensional hierarchy and a second list of items representing other dimensions of said multi-dimensional hierarchy, the item navigation device being enabled to receive a selection of a displayed item, wherein upon selection of an item from said first list, the apparatus is arranged to display a third list of items belonging to a lower hierarchical level for enabling further selection of displayed items, wherein said third list is hierarchically associated with the selected item; and upon selection of an item from said second list, the apparatus is arranged to display a fourth list of items belonging to a dimension of said multi-dimensional hierarchy associated with the selected item.

12. The apparatus according to claim 11, being arranged to enable selection from any displayed list and display items accordingly until a desired item for rendering is selected.

13. The apparatus according to claim 11, further comprising a media renderer arranged to render a media item associated with said selected item upon selection of a media item.

14. The apparatus according to claim 11, wherein said inserted third list is indented compared to said first list.

15. The apparatus according to claim 11, wherein, upon selection of an item from said second list, said first list of items is concealed, and an item representing the dimension of said concealed first list is inserted into said second list of items.

16. A computer-readable medium having computer-executable components comprising instructions for displaying a first list of items belonging to a dimension of said multi-dimensional hierarchy in a display view;
displaying second list of items representing other dimensions of said multi-dimensional hierarchy in said display view;
enabling selection of a displayed item;
upon selection of an item from said first list, displaying a third list of items belonging to a lower hierarchical level for enabling further selection of displayed items, wherein said third list is hierarchically associated with the selected item; and
upon selection of an item from said second list, displaying a fourth list of items belonging to a dimension of said multi-dimensional hierarchy associated with the selected item.

17. The computer-readable media according to claim 16, comprising instructions for selecting from any displayed list and displaying items accordingly until a desired item for rendering is selected.

18. The computer-readable media according to claim 16, further comprising instructions for rendering a media item associated with said selected item upon selection of a media item.

19. The computer-readable media according to claim 16, further comprising instructions for indenting said inserted third list compared to said first list.

20. The computer-readable media according to claim 16, further comprising instructions for, upon selection of an item from said second list, concealing said first list of items; and inserting into said second list of items an item representing the dimension of said concealed first list.
